(19) United States
(12) Patent Application Publication
(10) Pub. No.: US 2006/0077767 A1
(43) Pub. Date: Apr. 13, 2006

(54) Dialog-reading game with background music and sound effects cued to text

(76) Inventor: Richard Young, Northridge, CA (US)

Correspondence Address: Wilson Daniel Swayze, Jr., 3804 Clearwater Ct, Plano, TX, 75025, US

(21) Appl. No.: 11/219,959

(22) Filed: Sep. 6, 2005

Related U.S. Application Data
(60) Provisional application No. 60/609,497, filed on Sep. 13, 2004.

(51) Int. Cl. G11B 21/08

(52) U.S. Cl. 369/30.01

(57) ABSTRACT

A game for a first user and a second user includes the steps of selecting from a title from a menu, displaying a first line of text corresponding to the title to the first user, playing the first audio segment corresponding to the first line of text, reading the first line of text, displaying a second line of text corresponding to the title to the second user, playing a second audio segment corresponding to the second line of text and reading the second line of text.

### PRIORITY

The present invention claims priority under 35 USC Section 119 based on provisional patent application Ser. No. 60/609,497 filed on Sep. 13, 2004.

### FIELD OF THE INVENTION

The present invention relates to a game and more particularly to a game used with a system, apparatus and method for transmitting and displaying sounds, text, and/or video for users to talk or act.

### BACKGROUND OF THE INVENTION

The phenomenon of karaoke entertainment in United States and the rest of the world in which users listen or sing-along with their favorite music is a popular form of entertainment. The user of this karaoke entertainment is for a period of time a pop singer or superstar as he/she sings along with their favorite music. Karaoke software allows users who do not know the words to the song the ability to sing-along by following the continuous lyrics scrolling across the screen of a monitor.

Karaoke is a Japanese abbreviated compound word; ‘Kara’ comes from ‘karappo’ meaning empty and ‘oke’ is the abbreviation of ‘okesurture’ or orchestra. Usually, a music disc includes vocals and accompaniment, but a disc that includes only accompaniment is known as a karaoke CD or a karaoke disc.

Karaoke started in Japan and has moved to the United States and the rest of the world and now is available in almost every language. The first format for karaoke was actually on an audio cassette tape, but the format was limited because it did not have any lyrics available for the singer to see except for on printed sheet music.

In the early 1990s, the Pioneer Corporation created 12 inch karaoke discs in laser format similar to the laser videodisc for popular movies. The laser format was very popular because the lyrics to the accompaniment music could be played on the TV screen in time with the music.

The problem with karaoke is that all of the lyrics must be sung, which, for the nonsinging public may create a source of embarrassment or uncomfortableness. Furthermore, with the typical karaoke format, a single performer sings all of the lyrics from start to finish. There is no interruption of the lyrics until the song has finished. Furthermore, the user cannot control the pace of the karaoke; slowing or speeding up the accompaniment music or the lyrics would destroy the song.

### SUMMARY OF THE INVENTION

The apparatus and method of the present invention overcomes the above-mentioned deficiencies and creates a game that is both interesting and fun, allowing the nonsinging public to participate without fear and intimidation. The game of the present invention allows different users to take turns reading dialogue text out loud while being synchronized or cued to music and/or to sound effects that are playing in the background. The text is displayed on video which may be in the form of a video monitor while the audio referred to as an audio segment is played through electronic speakers. The audio segment selected is appropriate for the video but does not necessarily need to be synchronized to the words shown as text on the video monitor. The video monitor and electronic speakers could be a standard television set or other apparatus as would be appropriate. After the first user has completed reading a line of text chosen or assigned to the first user, a signal is given by the first user that he/she has finished reading the line of text. While the present invention uses a line of text to determine what the user is reading, other amounts or types of text for example two or three lines of text or a paragraph of text is within the scope of the invention. This signal may be generated by a button on a remote control unit and may be transmitted to a controller which is controlling the video and audio. Next, the second user reads a second line of text chosen or assigned to him or her with the appropriate audio for that line of text being displayed. Again, the audio is not necessarily synchronized to any particular word that is shown as video. This process continues until all the users have had a turn reading a line of text with the accompanying audio. At this point, the first user now reads a third line of text which may or may not have some relationship to the first line of text assigned to or chosen by the first user. While the first user is reading the third line of text, again audio is played which may correspond to the third line of text, and the process continues for each of the users and continues until all of the lines of the text have been read.

The present invention has the following advantages over existing karaoke inventions. The users of the present invention read text of dialogue instead of having to be embarrassed by being required to sing lyrics of songs. Additionally, multiple users are able to control the pace of the game by pressing a single button after each line of text is read.

The present invention has the following advantages over existing teleprompter inventions. The present invention is a game which includes audio and is not meant merely as an aid for reading speech text. The pace of advancement of text lines is controlled by the user pressing a button on a remote control unit after each line of text is read. The dialogue reading game of the present invention provides for audio or audio segments including cued background music and sound effects that correlates to the text being read by the users.

### BRIEF DESCRIPTION OF THE DRAWINGS

FIG. 1 illustrates the system or apparatus of the present invention;

FIGS. 2a and b illustrate a flow chart of the present invention.

### DETAILED DESCRIPTION

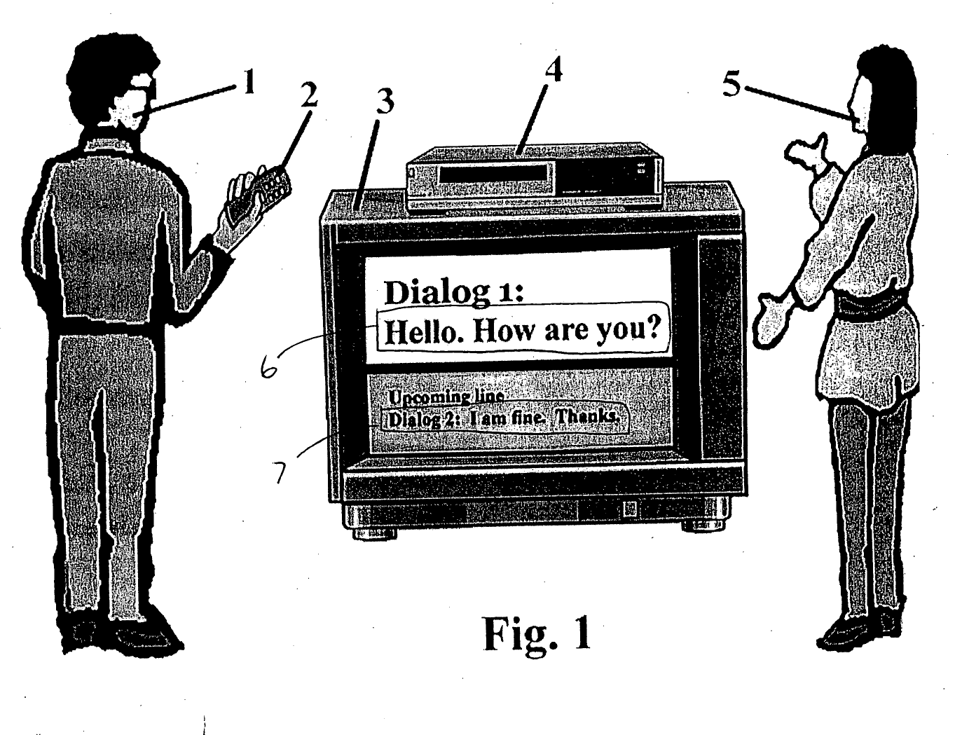

FIG. 1 shows a first user 1 and a second user 5 participating in the game of the present invention. The first user 1 is holding a remote control unit 2 for the controller 4 which could be a computer, DVD player, modified karaoke machine, video game console or any apparatus suitable to control audio and video from programmed data. The controller 4 displays the current line of text 6 on the video monitor 3 which could be a television, computer monitor, cell phone or any other apparatus suitable to display video. The controller 4 starts playing the first audio segment which may be background music or sound effects associated with the current line of text 6. The first user 1 or another person presses a button on the remote control unit 2 to indicate to the controller 4 that the first user 1 has completed reading the current line of text 6 presented to the first user 1. The controller changes the display of the video monitor 3 so that the current line of text 6 is no longer displayed, the next line of text 7 is displayed as the new current line of text 6 and the following line of text is displayed as the new next line of text 7. The controller 4 either continues playing the audio from the previous audio segment or stops the audio and begins playing a different background music and sound effects, whichever is required as being the second audio segment associated with the new current line of text 6. The controller continues displaying the new lines of text 6 and 7 and continues playing the second audio segment until the button on the remote control unit 2 is pressed by either the first user 1, the second user 5 or another person. Each time the button on the remote control unit 2 is pressed the controller 4 changes the display on the video monitor 3 so that the current line of text 6 is no longer displayed, the next line of text 7 is displayed as the new current line of text 6 and the following line of text is displayed as the new next line of text 7. And the controller 4 begins playing the next audio segment which may be a continuation of the previous audio segment or a different background music or sound effects.

The line of text may be a word, a phrase, a sentence, a fragment, a paragraph or several paragraphs. The controller may display the line of text or multiple lines of text on a single video monitor 3 or on multiple screens so that each user, the audience and the person pressing the button on the remote control unit 2 may each share display screens or have their own display screens.

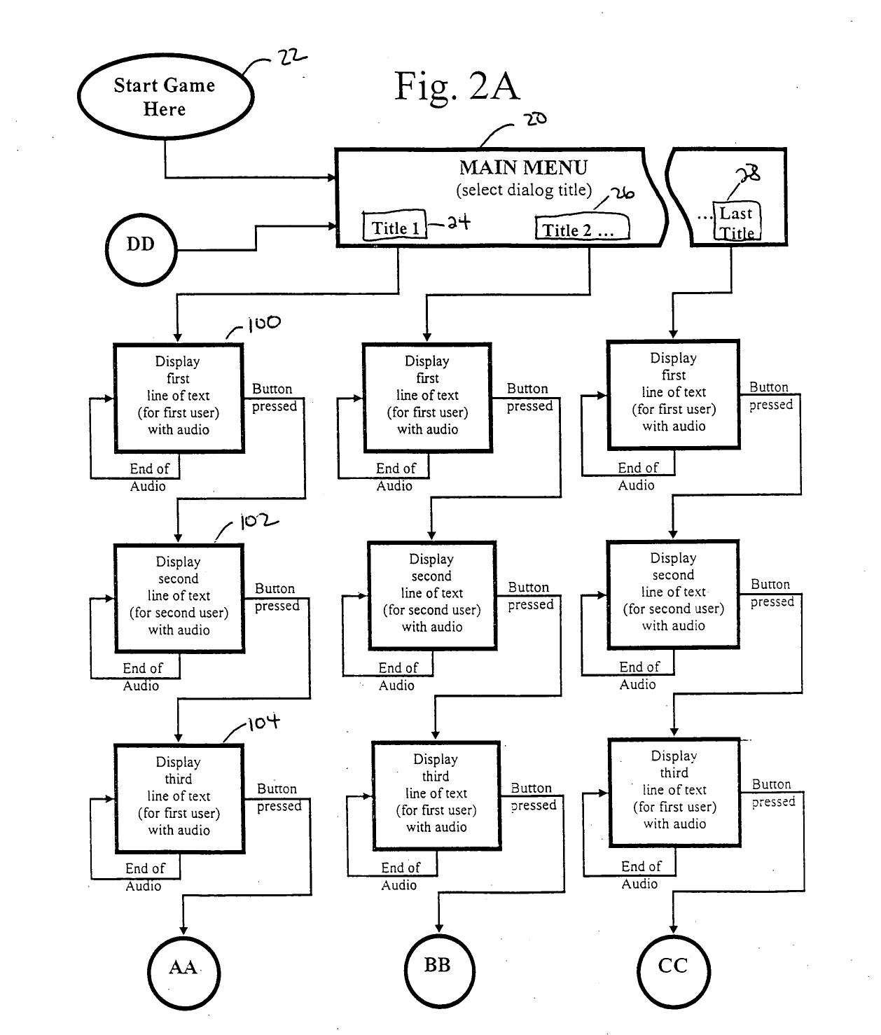

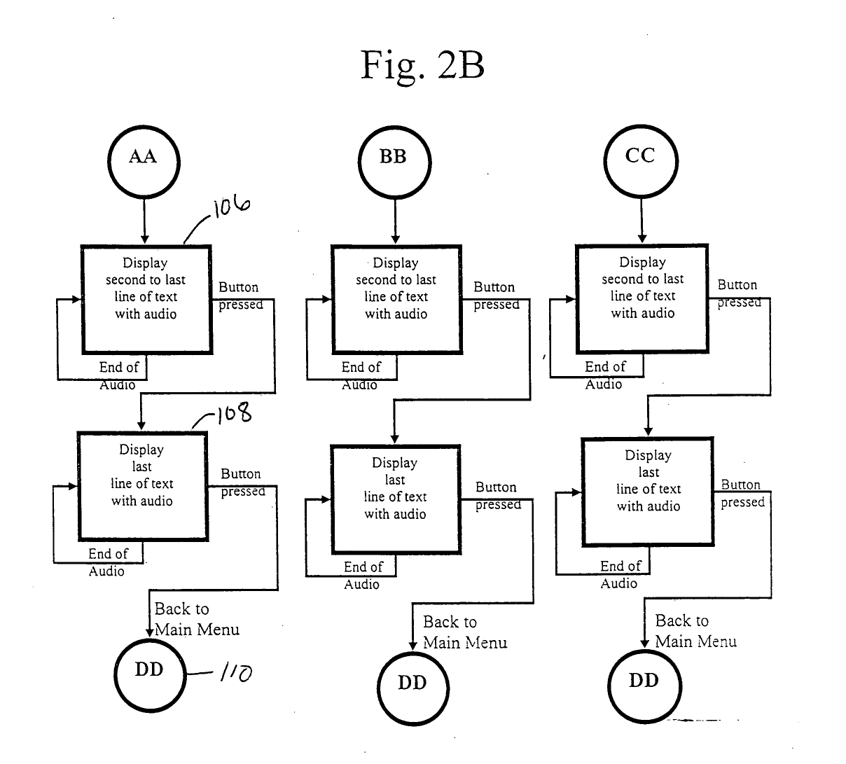

FIG. 2 shows the sequence of steps for the operation of the game of the present invention. In step 22, the game is started, and in step 20, the main menu is displayed on the video monitor 3 including the titles which are available for the game. For example, the main menu discloses a first title 24, a second title 26 and a last title 28. One 1, 5 of the users selects one of the titles, and the game begins. Control passes to step 100 in which the first line of the first title 24 is shown to the first user 1 and a corresponding first audio segment which may be cued background music or sound effects is played. If the first audio segment ends before the first user 1 finishes the first line, the first audio segment begins again from the beginning.

When the first user 1 or another person presses the button on the remote control unit 2, the controller 4 passes control to step 102 where the second line of text of first title 24 is displayed for the second user 5 and where the second audio segment that corresponds to the second line of text of first title 24 is played. If the second audio segment should end before the second user 5 completes reading the second line of text, the second audio segment begins again.

When the second user 5 has completed reading the second line of text, one of the users 1,5 or another person will press the button of the remote control unit 2 so that the controller 4 will display the third line of text of the first title 24.

In step 104, the controller 4 displays the third line of text of the first title 24 for the first user 1 and plays the third audio segment corresponding to the third line of text. After the first user 1 has read the third line of text, one of the users 1,5 or another person will press the button of the remote control unit 2 so that the controller 4 will display the next line of text and eventually display the second to last line of text in step 106.

In step 106, the controller 4 displays the second to last line of text of the first title 24, and the controller 4 plays the second-to-last audio segment corresponding to the second-to-last line of text. After the corresponding user has finished reading the second-to-last line of text, the one of the users 1,5 or another person presses the button of the remote control unit 2 so that the controller 4 will display the last line of text corresponding to the first title 24.

In step 108, the controller 4 displays the last line of text of the first title 24 and the controller 4 plays the last audio segment corresponding to the last line of text of the first title 24. The corresponding user reads the last line of text of the first title 24. If the audio segment corresponding to the last line of text of the first title 24 ends before the corresponding user is finish reading the last line of text, the audio segment will begin again. When the corresponding user is finished reading the last line of text of the first title 24, one of the users 1, 5 or another person pushes the button on remote control 2, and the controller 4 returns to the main menu 20 in step 110.

The controller 4 allows the first user 1, the second user 5 or another person to select another dialog title or to exit the game. If is the first user 1, the second user 5 or another person selects the second title 26 and the process begins again with the first user 1 and the second user 5 alternately reading lines of text corresponding to the second title 26 while corresponding audio segments are being played.

The controller 4 will display the lines of text corresponding to the second title 26 in a similar fashion as described with respect to steps 100-108. The controller 4 will display the lines of text corresponding to each title available through the main menu 20 in accordance with the first user 1 or the second user 5. Eventually, the controller 4 will select the last title 28 and display the lines of text corresponding to this last title 28 in a similar fashion as described with respect to steps 100-108.

As a result of the above mentioned steps and apparatus, the invention has advantages over karaoke. The users of the present invention read text of dialogue instead of being embarrassed while singing lyrics of song, and these users are able to control the pace of the game by moving to the next step when a signal is received by the controller 4.

As a result of the above mentioned steps, the present invention has the advantage over teleprompter in that the present invention is a game of amusement instead of an aid for reading speech text. Again, the users of the game are able to control the pace of the game instead of having the teleprompter apparatus controlling the pace of the text. The present invention provides for cued background music and sound effects that may correlate or may have a connection to the text being read by the users. In contrast, the teleprompter generally has no music or sounds associated with the text.

A standard video DVD player could contain the interactive audio and video for playing the game. The DVD player with its remote controller could act as the controller 4 and remote controller 2 as described above. The user 1 or the user 5 inserts and plays a specially prepared DVD in the standard DVD player 4. The users 1, 5 takes turns reading out the lines of text recorded on the DVD and displayed on the video monitor or television set 3. The game is enhanced by audio segments again recorded on the DVD which could be background music and sound effects. Instead of the DVD, a random-access storage device such as the CD-ROM, a hard drive or memory chip could be programmed with the lines of text and audio segments to provide additional flexibility. Additionally, a complete console system such as a home entertainment system including a media player, video display, audio speakers and remote control could be used to implement the present invention. Alternatively, the present invention could be implemented in video game consoles, such as PlayStation, X-box, Game Cube or karaoke consoles.

Although embodiments of the invention have been described in the foregoing detailed description and illustrated in the accompanying drawings, it will be understood that the invention is not limited to the embodiments disclosed, and particularly to game applications, but is capable of rearrangements, modifications, and substitution of parts and elements as well as use in numerous devices requiring a game of skill. The present invention is therefore intended to encompass such rearrangements, modifications and substitutions of parts and elements that fall within the spirit and scope of the invention.

1) A game for a first user and a second user, comprising the steps of:
selecting a title from a menu;
displaying a first line of text corresponding to said title to said first user;
playing a first audio segment corresponding to said first line of text;
reading said first line of text;
displaying a second line of text corresponding to said title to said second user;
playing a second audio segment corresponding to said second line of text; and
reading said second line of text.

2) A game for a first user and a second user as in claim 1 wherein the step of reading said first line of text is performed by said first user.

3) A game for a first user and a second user as in claim 1 wherein the step of reading said second line of text is performed by said second user.

4) A game for a first user and a second user as in claim 2 wherein the step of displaying said first line of text is ended by said first user being finished reading said first line of text.

5) A game for a first user and a second user as in claim 3 wherein the step of displaying said second line of text is ended by said second user being finished reading said second line of text.

6) A game for a first user and a second user as in claim 4 wherein the step of playing the first audio segment continues until the first user ends displaying said first line of text.

7) A game for a first user and a second user as in claim 5 wherein the step of playing the second audio segment continues until the second user ends displaying the second line of text.

8) A game for a first user and a second user as in claim 3 wherein the method includes the step of displaying the main menu following the corresponding user ending the display of the last line of text.

9) A game for a first user and a second user as in claim 8 wherein a new title is chosen after the corresponding user ends of the display of the last line of text.

10) An apparatus to aid in using a game for a first user and a second user, comprising:
a video monitor for displaying a title selected from a menu;
said video monitor displaying a first line of text corresponding to said selected title;
a speaker apparatus for playing a first audio segment corresponding to said first line of text;
a controller for controlling the display on said video monitor and for controlling said speaker apparatus so that said first audio segment corresponds to said first line of text, said controller controlling the video monitor to display a second line of text corresponding to said title and controlling said speaker apparatus to play a second audio segment corresponding to the second line of text.

11) An apparatus to aid in using a game for a first user and a second user as in claim 10 wherein said controller displays said second line of text after said first user signals said controller.

12) An apparatus to aid in using a game for a first user and a second user as in claim 10 wherein said controller displays a third line of text after said second user signals said controller.

13) An apparatus to aid in using a game for a first user and a second user as in claim 10 wherein said controller continuously plays said first audio segment while said first line of text is displayed.

14) An apparatus to aid in using a game for a first user and a second user as in claim 10 wherein said controller continuously plays said second audio segment while said second line of text is displayed.

15) An apparatus to aid in using a game for a first user and a second user as in claim 10 wherein said controller displays the main menu after the corresponding user has ended the last line of text.
